(19) United States
(12) Patent Application Publication
(10) Pub. No.: US 2025/0218011 A1
(43) Pub. Date: Jul. 3, 2025

(54) INFORMATION PROCESSING METHOD AND DEVICE

(71) Applicant: Lenovo (Beijing) Limited, Beijing (CN)

(72) Inventor: Wentao SUN, Beijing (CN)

(21) Appl. No.: 19/000,675

(22) Filed: Dec. 23, 2024

(30) Foreign Application Priority Data
Dec. 29, 2023 (CN) 202311865659.9

(51) Int. Cl. G06T 7/50; G06F 21/32

(52) U.S. Cl. CPC G06T 7/50; G06F 21/32

(57) ABSTRACT

An information processing method includes obtaining target data, in a first scenario, outputting the target data in a first method, and in a second scenario, outputting the target data in a second method. The first scenario is different from the second scenario. Environment expression corresponding to the first scenario is consistent with environment expression corresponding to the target data. Environment expression corresponding to the second scenario is inconsistent with the environment expression corresponding to the target data.

### CROSS-REFERENCE TO RELATED APPLICATION

This application claims priority to Chinese Patent Application No. 202311865659.9, filed on Dec. 29, 2023, and the entire content of which is incorporated herein by reference.

### TECHNICAL FIELD

The present disclosure relates to the field of data processing technology, specifically to an information processing method, an information processing device, and a storage medium.

### BACKGROUND

With the development of multimedia technology, the methods of conveying information have become increasingly diverse. For example, audio and video containing various elements such as images, sound, and text, as a form of media, provide a more intuitive and realistic way of conveying information. Particularly with the support of devices like mobile terminals, anyone can capture and share audio and video at any time and any place If this issue is not addressed, the accompanying privacy concerns become increasingly problematic.

### SUMMARY

One aspect of the present disclosure provides an information processing method. The method includes obtaining target data, in a first scenario, outputting the target data in a first method, and in a second scenario, outputting the target data in a second method. The first scenario is different from the second scenario. Environment expression corresponding to the first scenario is consistent with environment expression corresponding to the target data. Environment expression corresponding to the second scenario is inconsistent with the environment expression corresponding to the target data.

Another aspect of the present disclosure provides an information processing device, including an acquisition module, a first output module, and a second output model. The acquisition module is configured to obtain target data. A first output module is configured to output the target data in a first method in a first scenario. A second output module is configured to output the target data in a second method in a second scenario. The first scenario is different from the second scenario. The environment expression corresponding to the first scenario is consistent with the environment expression corresponding to the target data. Environment expression corresponding to the second scenario is inconsistent with the environment expression corresponding to the target data.

Another aspect of the present disclosure provides an information processing device. The device includes a first output module for outputting target data in a first method, if in a first scenario; a second output module for outputting target data in a second method if in a second scenario, wherein the first scenario is different from the second scenario, the environment expression corresponding to the first scenario is consistent with the environment expression corresponding to the target data, and the environment expression corresponding to the second scenario is inconsistent with the environment expression corresponding to the target data.

The third aspect of the present disclosure provides a computer-readable storage medium. The storage medium stores the computer program. When the processor executes the computer program, the aforementioned method is implemented. The storage medium can be volatile or non-volatile.

### BRIEF DESCRIPTION OF THE DRAWINGS

To more clearly illustrate the technical solutions in the embodiments of the present disclosure, drawings required for the description of the embodiments are briefly described below. Obviously, the drawings described below are merely some embodiments of the present disclosure. For those skilled in the art, other drawings can be obtained based on these drawings without creative efforts.

FIG. 1 is a flowchart illustrating the information processing method according to an embodiment of the present disclosure.

FIG. 2 is another flowchart illustrating the information processing method according to an embodiment of the present disclosure.

FIG. 3 is a schematic diagram of the target data frame according to an embodiment of the present disclosure.

FIG. 4 is a schematic diagram of the point cloud information in the target information according to an embodiment of the present disclosure.

FIG. 5 is a schematic diagram of the storage structure of the target data according to an embodiment of the present disclosure.

FIG. 6 is a flowchart illustrating the method for generating the target data according to an embodiment of the present disclosure.

FIG. 7 is a schematic diagram of the storage structure of the target data frame according to an embodiment of the present disclosure.

FIG. 8 is another flowchart illustrating the information processing method according to an embodiment of the present disclosure.

FIG. 9 is a schematic diagram of the information processing device according to an embodiment of the present disclosure.

FIG. 10 is a schematic diagram of the hardware entity of the electronic device according to an embodiment of the present disclosure.

### DETAILED DESCRIPTION OF THE EMBODIMENTS

To enable those skilled in the art to better understand the technical solutions of the embodiments of the present disclosure, the technical solutions in the embodiments of the present disclosure will be clearly and completely described below in conjunction with the accompanying drawings. Obviously, the described embodiments are merely part of the embodiments of the present disclosure, not all of the embodiments. Based on the embodiments of the present disclosure, all other embodiments obtained by those skilled in the art without creative work are within the scope of the present disclosure.

It should be noted that the terms ‘first,’ ‘second,’ and ‘third’ as used in the embodiments of the present application are merely for distinguishing similar objects and do not represent any specific order of those objects. It is to be understood that ‘first,’ ‘second,’ and ‘third’ may be interchanged in certain instances, where applicable, to allow the embodiments of the present application described herein to be implemented in an order different from what is illustrated or described.

It should be understood by those skilled in the art that, unless otherwise defined, all terms used herein (including technical and scientific terms) have the same meaning as commonly understood by one of ordinary skill in the art to which the embodiments of the present application belong. It should also be understood that terms such as those defined in commonly used dictionaries should be interpreted as having meanings consistent with the context of the relevant prior art, and unless specifically defined herein, should not be interpreted in an idealized or overly formal sense.

In the related art, with the development of multimedia technology, with the development of multimedia technology, the methods of conveying information have become increasingly diverse. For example, audio and video containing various elements such as images, sound, and text, as a form of media, provide a more intuitive and realistic way of conveying information. Particularly with the support of devices like mobile terminals, anyone can capture and share audio and video at any time and any place If this issue is not addressed, the accompanying privacy concerns become increasingly problematic.

The present disclosure provides an information processing method. In this method, by comparing an environment expression corresponding to target data with an environment expression corresponding to the scenario, and outputting the target data in different settings (e.g., displaying the target data or not displaying the target data), it ensures that the target data is only displayed in specific scenarios. This method enhances the privacy and security of the target data. Additionally, by determining the setting of outputting the target data, based on environment expression comparison, in contrast to using specific encryption methods to encrypt the target data, this method does not require to store additional encryption resources. This reduces the consumption of storage resources on various device ends (e.g., encryption end and decryption end). Furthermore, since additional encryption and decryption processes are not required, this method reduces the resource consumption at the device end, and also increases the speed of obtaining the target data. This method provided by the present disclosure can be executed by various electronic devices, including virtual reality (VR) devices, augmented reality (AR) devices, mixed reality (MR) devices, laptops, tablets, desktop computers, set-top boxes, mobile devices (e.g., mobile phones, portable music players, personal digital assistants, dedicated messaging devices, portable gaming devices), and other types of terminals. Moreover, the method can also be implemented on servers. The server can be a standalone physical server, a server cluster composed of multiple physical servers, or a distributed system. It can also be a cloud server providing foundational cloud computing services such as cloud services, cloud databases, cloud computing, cloud functions, cloud storage, network services, cloud communication, middleware services, domain name services, security services, content delivery network (CDN), as well as big data and artificial intelligence platforms.

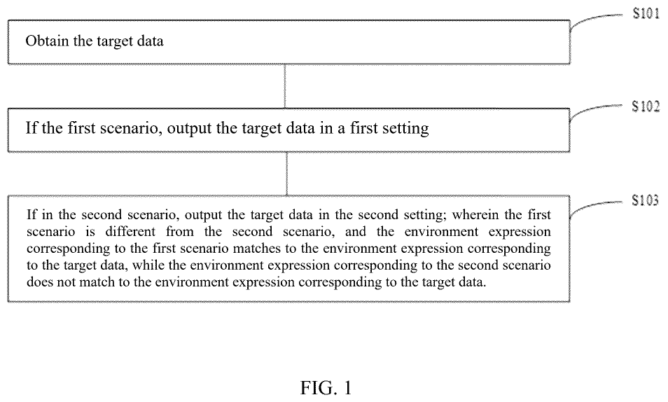

FIG. 1 is a flowchart illustrating an information processing method according to an embodiment of the present application. As shown in FIG. 1, the method includes steps S101 to S103.

At S101: obtaining target data.

In this case, the target data can be any suitable type of data. For example, the target data includes, but is not limited to, audio and video (a complete video file or at least one image frame within it), images, or other multimedia files.

The target data can be obtained in any suitable manner. For example, the data can be received from other electronic devices. Alternatively, the target data can be actively read from other electronic devices. Additionally, the target data can be read locally. In some embodiments, target data can be obtained from other electronic devices through transmission interfaces or data transmission protocols. For example, target data can be obtained from other electronic devices through interfaces such as High Definition Multimedia Interface (HDMI) or Universal Serial Bus (USB). Similarly, target data can be obtained via data transmission protocols such as Transmission Control Protocol (TCP) or User Datagram Protocol (UDP). Furthermore, target data can also be obtained from cloud services through interfaces like Configuration Management Database (CMDB) or File Transfer Protocol (FTP).

At S102, if in the first scenario, outputting the target data in a first method.

In this case, the first scenario refers to a scenario where the environment expression corresponding to the scenario is matches to the environment expression corresponding to the target data. Note that the environment expression refers to the expression of the environment where the data is situated, based on environmental information. The environment expression may be included in the target data, or obtained by parsing the target data.

The first method can be any suitable setting. For example, the setting can be displaying the target data on the target device.

In some embodiments, the target device used to obtain the target data and the target device used to output the target data can either be a same electronic device, or be different electronic devices.

In some embodiments of the present disclosure, when determining whether the first scenario is present, the environment expression corresponding to the current scenario can be extracted from the environmental information of the current scenario. Then, the environment expression of the current scenario is compared with the environment expression corresponding to the target data to determine whether the first scenario is present. For example, if the environment expression of the current scenario completely matches to the environment expression corresponding to the target data, it is determined that the first scenario is present.

In some embodiments of the present disclosure, the first scenario can also be determined whether there is a partial match between the environment expression of the current scenario and the environment expression corresponding to the target data.

At S103, if in the second scenario, outputting the target data in the second method; wherein the first scenario is different from the second scenario, and the environment expression corresponding to the first scenario matches to the environment expression corresponding to the target data, while the environment expression corresponding to the second scenario does not match to the environment expression corresponding to the target data.

In this case, the second scenario refers to a scenario where the environment expression corresponding to the scenario does not match to the environment expression corresponding to the target data.

The second method can be any suitable setting different from the first method. For example, the second method can be not displaying the target data on the target device. Not displaying the target data can include blurring the target data on the target device, displaying only part of the target data, or displaying preset data instead. The preset data can be any suitable data which is different from the target data. For example, the preset data could be other pre-stored data. Alternatively, the preset data could be different from the target data and be obtained by the target device from an external device.

In some embodiments of the present disclosure, when determining whether the second scenario is present, the environment expression corresponding to the current scenario can be extracted from the environmental information of the current scenario. Then, the environment expression of the current scenario is compared with the environment expression corresponding to the target data to determine whether the second scenario is present. For example, if the environment expression of the current scenario and the environment expression corresponding to the target data are completely different, it is determined that the second scenario is present.

In some embodiments of the present disclosure, if the environment expression of the current scenario and the environment expression of the target data are not completely matched, it is determined that the second scenario is present.

Taking the target data as an audio-video file as an example, if the video capture device records a video of a themed meeting in Meeting Room A, the video can only be viewed on the video playback device when it is in Meeting Room A, and it cannot be played in Meeting Room B. Similarly, if the target data is an image, and the image capture device takes a photo of a cup in Room C, the image can only be displayed on the image display device when it is in Room C, and it cannot be displayed in Meeting Room B.

In some embodiments of the present disclosure, by comparing the environment expression of the target data with the environment expression of the scenario and outputting the target data in different settings (e.g., displaying or not displaying the target data), the target data can only be displayed in a specific scenario. This effectively enhances the privacy and security of the target data. Additionally, in contrast to encrypting the target data using specific encryption methods, determining the setting of outputting the target data based on the comparison of environment expressions, firstly avoids the requirement of storing extra encryption resources, secondly reduces storage resources consumption on multiple devices (e.g., both encryption and decryption ends). Furthermore, since extra encryption and decryption processes are not required, this not only reduces resource consumption on each device, but also increases the speed of data accessing.

In some embodiments of the present disclosure, the first method is displaying the target data on the target device, and the second method is not displaying the target data on the target device.

In this case, the setting of not displaying the target data can include blurring the target data on the target device, displaying only part of the target data, or displaying preset data instead.

In the embodiments of the present disclosure, by displaying the target data in the first method, and not displaying the target data in the second method, it ensures that the target data can be only displayed in specific scenarios, which effectively improves the privacy protection and security of the target data.

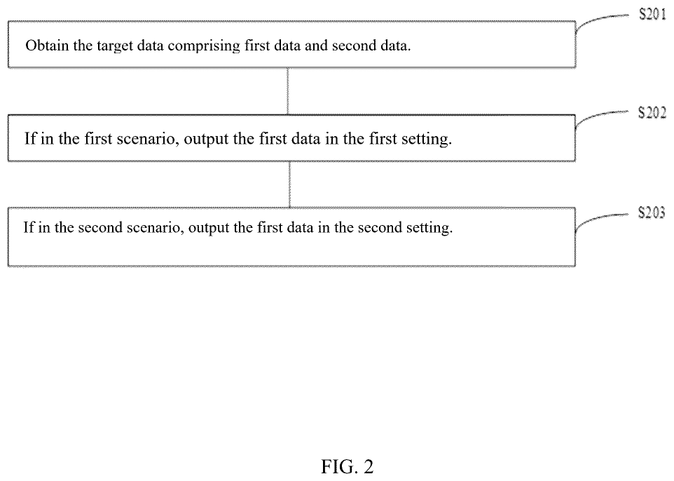

FIG. 2 is another flowchart illustrating the information processing method according to an embodiment of the present disclosure. As shown in FIG. 2, the method includes steps S201 to S203, wherein:

At S201, obtaining the target data comprising the first data and the second data. The first data is data of a first object, and the second data represents the environment expression of a capture device at the time of capturing the first data. The environment expression corresponding to the target data is reflected through the second data.

In this case, the target data can be any suitable data. In this embodiment, the target data includes first data and second data. The first data can be data of the first object, wherein the first object can be any suitable object. For example, in the case of virtual capture, the first object can be a virtual object, and in the case of real-world capture, it could be a real object. The first data is used for displaying or not displaying, while the second data is used for matching the environment expression or for output display. These two data streams can function independently.

In some embodiments of the present disclosure, taking an audio-video file as an example, the target data may include one or more target data frames. A target data frame is composed of one frame of the first data and one frame of the second data. The second data can be index information, environment expression data, etc. This index information is used during the process of determining whether the first scenario is present, to read the corresponding environment expression data from the target information. The target information contains all the indexes and the corresponding environment expression data.

The second data represents the environment expression of the capture device at the time capturing the first data, which corresponds to the physical space where the capture device is located. The environment expression is obtained based on environmental information. The capture device is a device capable of capturing environmental information. Environment expression refers to characteristic information from the environmental information that can represent a certain environment. For example, by extracting features from the point cloud data collected by the capture device, a set of feature points is obtained, and the feature point set is used as the environment expression.

In some embodiments of the present disclosure, the second data may include, but is not limited to, environmental information captured by the capture device at the time of capturing the first data (such as 2D RGB images or 3D point cloud information). Different types of environmental information correspond to different data storage and transmission methods, as well as different matching methods for environment expressions. Detailed descriptions of these will be provided in the following embodiments and will not be elaborated here.

In implementation, multiple feature points can be extracted from the environmental information, and the set of feature points can be used as the environment expression. The dimensionality of the feature points can be two-dimensional, three-dimensional, etc. In some embodiments, the capturing capability of different capture devices are different, and their corresponding environmental information can be also different. For example, when using a 2D camera as the capture device, the extracted feature points from the environmental information are two-dimensional. Similarly, when using a depth camera as the capture device, the extracted feature points from the environmental information are three-dimensional.

In some embodiments of the present disclosure, the capture device and the target device outputting the target data can be the same device or different devices.

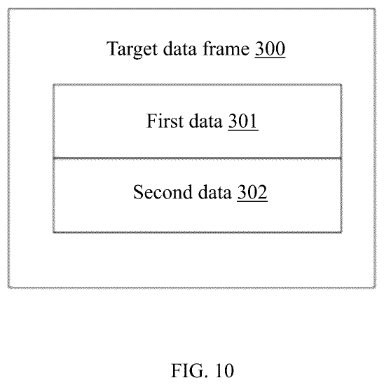

FIG. 3 is a schematic diagram of a target data frame according to an embodiment of the present application. As shown in FIG. 3, the target data frame 300 includes first data 301 and second data 302.

More specifically, the first data 301 is data of the first object.

Moreover, the second data 302 represents the environment expression of the capture device at the time of capturing the first data 301. The second data may include the environmental information captured by the capture device at the time of capturing the first data. The types of environmental information include, but are not limited to, 2D RGB images or 3D point cloud information. Considering data transmission efficiency, there can be multiple options of the amount of the data about the environmental information in the target device, and different amounts of data correspond to different storage formats. For example, the data can be stored in a form of index. This index information is used to retrieve the environment expression of the capture device at the time of capturing the first data, from the target information. The size of the index data is much smaller than the data itself. However, not all situations are suitable for index storage, and the storage strategy should be determined based on specific needs, which will be described in detail below.

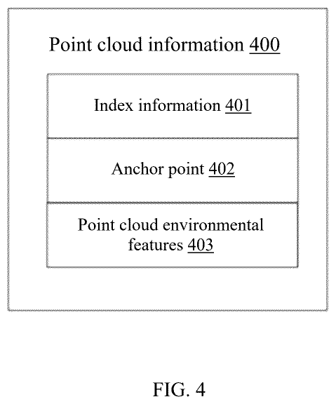

FIG. 4 is a schematic diagram of point cloud information according to an embodiment of the present application. As shown in FIG. 4, the point cloud information 400 includes index information 401, anchor point 402, and point cloud environmental features 403.

Index information 401 is used to obtain the corresponding environment expression from the target information.

Anchor point 402 is used to mark a specific real object and represents the current object's coordinate system, position, rotation, and scale. It can describe the location of an object. The anchor point is calculated from the object and can be the center of mass or the geometric center of the object. For regularly shaped objects, the anchor point can be either the center or the center of mass. For irregularly shaped objects, the center of mass is preferred as the anchor point. Through the anchor point, virtual information can be accurately superimposed on the real object, aligning the real object with the virtual information to ensure proper display.

Point cloud environmental features 403 are data characteristics from the environmental information that can represent a specific environment.

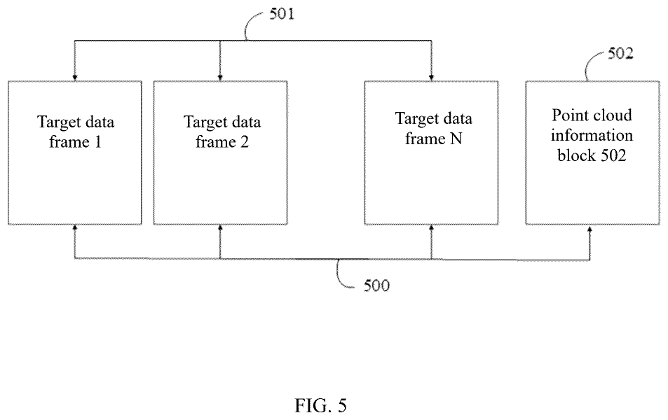

FIG. 5 is a schematic diagram of the storage structure of target data according to an embodiment of the present application. As shown in FIG. 5, the target data 500 includes multiple target data frames 501 (where the environmental information is 3D point cloud information stored in an indexed format) and a point cloud information block 502 (corresponding to the aforementioned target information). The point cloud information block 502 is used to store all environment expressions.

At S202, if in the first scenario, outputting the first data in the first method.

In this case, the first scenario refers to a scenario where the environment expression of the scenario matches to the environment expression of the target data. The first method can be any suitable setting, such as displaying the first data on the target device. In some embodiments, the set of feature points extracted from the environmental information captured by the capture device is used as the environment expression. The dimensionality of the feature points can include, but is not limited to, two-dimensional or three-dimensional. The two-dimensional data is typically expressed as a set of coordinate points in a Cartesian coordinate system, including vertical and horizontal coordinate values. The three-dimensional data is usually expressed as a set of coordinate points in a 3D coordinate system, including the coordinate values along three mutually perpendicular axes in 3D space. In implementation, when comparing environment expressions, the dimensionality of the feature points in the environment expression corresponding to the target data is consistent with the dimensionality of the feature points in the environment expression corresponding to the first scenario.

The target device can be any suitable device, which is capable to play the target data. The target device may include, but is not limited to, a first type device, a second type device, a third type device, etc. The first type device requires outputting both the first data and the second data simultaneously, which can be a standard playback device or virtual reality devices. The standard playback devices can include, but are not limited to, computers, mobile terminals, etc. The second type device requires outputting only the first but not the second data, which can be augmented reality devices. The third type device can either output both the first data and the second data simultaneously, or output only the first data but not the second data, which can be mixed reality devices.

In some embodiments of the present disclosure, feature extraction is performed on the environmental information collected by the capture device, to obtain multiple feature points. Then the set of multiple feature points is used as the environment expression. The method of feature extraction can include, but is not limited to, extracting feature points from environmental information by calculating shape features of the environmental information, or extracting feature points from environmental information by any suitable neural network/model. Commonly used shape features include curvature, normal vectors, surface roughness, etc. For example, a point cloud is a collection of points that represent the spatial distribution and surface characteristics of the target in the same three-dimensional coordinate system. When the environmental information is a point cloud, if a point in the point cloud corresponds to a relatively large curvature, then the point can be considered as a feature point of the environmental information. As a consequence, multiple feature points can be obtained, and the set of these feature points can be used to represent the environment.

In some embodiments, feature extraction is performed on the environmental information collected by the capture device to obtain multiple feature points, and the set of feature points is used as the environment expression. For example, when the environmental information is an RGB image, feature extraction can be performed on the pixels of the RGB image to obtain multiple feature points, and the set of feature points is used as the environment expression. The methods for feature extraction on an RGB image may include, but are not limited to, the Histogram of Oriented Gradient (HOG) and Local Binary Pattern (LBP). For example, using HOG, the RGB image is divided into small connected regions, and then the gradient or edge orientation histograms of the pixels within each connected region are collected. Finally, by combining these histograms, multiple feature points can be obtained, and the set of feature points can be used as the environment expression.

At S203, if in the second scenario, outputting the first data in the second method.

Here, the second scenario refers to a scenario where the environment expression of the scenario does not match to the environment expression of the target data. The second method can be any suitable setting which is different from the first method. For example, the second method is not displaying the first data on the target device. The configurations of not displaying the first data can include blurring the first data on the target device, displaying only part of the first data from the target data, or displaying preset data instead. The preset data can be any suitable data and is different from the first data. For example, the preset data can be some pre-stored data. Alternatively, the preset data can be data obtained by the target device from an external device which is different from the first data.

In some embodiments of the present disclosure, by comparing the target data, which includes the first data and the second data, with the environment expression of the scenario, the first data can be output in different settings. This ensures that the first data of the target data is displayed only in specific scenarios, which enhances the privacy and security of the first data.

In some embodiments, the process of determining whether the first scenario is present includes the following processes. Firstly, if the target device is a first type device, the second data represents the environment expression of the two-dimensional and/or three-dimensional data of the capture device at the time of capturing the first data. Then, the third data is compared with the second data, and if the two data are matched, it is determined that the first scenario is present. Note that the third data represents the environment expression of the capture device at the time of capturing the third data, and the third data is two-dimensional and/or three-dimensional data. During the comparison, the dimension of the third data is same as the second data.

S202 includes step S111. At S111, outputting the first data and the second data in the first method, wherein the second data is used to determine the consistency of the environment expression and to display the output on the target device.

Here, the first type device refers to a device which is capable of playing the first data and the second data, simultaneously, such as standard playback devices, virtual reality devices, etc. The capture device refers to a device which is capable of capturing environmental information, such as a depth camera in virtual reality devices or a two-dimensional camera in mobile terminals.

The second data may include, but is not limited to, the environmental information captured by the capture device at the time of capturing the first data. In this case, the type of environmental information can include point cloud data, RGB images, etc. The environment expression is derived from this environmental information.

In some embodiments of the present disclosure, the first type device can output the first data and the second data (i.e., RGB images) after superimposing them. When superimposing the first data and the second data, anchor points can be used. An anchor point is used to label a specific real object, representing the coordinate system, position, rotation, scaling, etc. of the object, and describing the position of the object. The anchor point is calculated from the coordinates of the object, which can be the center of mass or the geometric center of the object. For regularly shaped objects, the anchor point can be the geometric center or the center of mass, while for irregularly shaped objects, the center of mass is typically selected. Using the anchor point, the first data can be correctly superimposed on the second data to ensure proper display.

The third data corresponds to the output data of the current scenario, but is not limited to, the environmental information captured by the capture device at the time of capturing the third data. The types of environmental information can include point cloud data, RGB images, etc. The environment expression is derived from this environmental information.

In some embodiments of the present disclosure, if the dimension of the second data is equal to that of the third data, the second data and third data can be directly compared to determine whether the first scenario is present.

In some embodiments, if the second data is three-dimensional and the third data is two-dimensional, the third data can first be converted into three-dimensional data, and then the converted third data can be compared with the second data to determine whether the first scenario is present. Alternatively, the second data can be converted into two-dimensional data, and then the converted second data can be compared with the third data to determine whether the first scenario is present. Methods for converting two-dimensional data into three-dimensional data can include, but are not limited to, Hilbert curves and Digital Elevation Models (DEM). Methods for converting three-dimensional data into two-dimensional data can include, but are not limited to, projection and feature extraction.

In some embodiments of the present disclosure, if the second data is three-dimensional and the third data includes both two-dimensional and three-dimensional data, the second data can be compared with the three-dimensional portion of the third data to determine whether the first scenario is present.

In the embodiments of the present disclosure, if the target device is capable to play both the first data and the second data, then the first data and the second data are both output when it is determined that the first scenario is present. Through this process, the accuracy of target data output has been improved. For example, using standard playback devices (PCs, mobile phones, etc.), cannot output the virtual object and the surrounding environmental video simultaneously. Therefore, the target data needs to include the surrounding environmental video captured along with the virtual object, so that both the virtual object and the surrounding environmental video shall be output simultaneously during playback.

In some embodiments of the present disclosure, the process of determining whether the first scenario is present includes: if the target device is a second type device, and the second data represents the two-dimensional or three-dimensional environment expression of the capture device at the time of capturing the first data, the third data is compared with the second data. If the two data are matched, it is determined that the first scenario is present. The third data represents the environment expression of the capture device at the time of capturing the third data, and the third data is two-dimensional or three-dimensional. During the comparison, the dimension of the third data is the same as the dimension of the second data.

S202 further includes step S112. At S112, outputting the first data in the first method, without outputting the second data, wherein the second data is used for determining the consistency of the environment expression.

In this case, the second type device refers to a device capable of playing the first data, such as augmented reality (AR) devices. The capture device is one capable of capturing environmental information, such as a depth camera or a two-dimensional camera in AR devices.

In some embodiments of the present disclosure, if the target device is a second type device (e.g., an AR device), the real environment (i.e., the third data) can be seen through the lenses of the AR device. When it is determined that the first scenario is present, the first data can be superimposed on the third data seen through the lenses. In practice, the first data can also be superimposed on the third data using anchor points.

In some embodiments of the present disclosure, if the dimension of the second data is the same as that of the third data, the second data and third data can be directly compared to determine whether the first scenario is present.

In some embodiments of the present disclosure, if the second data is three-dimensional and the third data is two-dimensional, the third data can first be converted into three-dimensional data, and then the converted third data can be compared with the second data to determine whether the first scenario is present. Alternatively, the second data can be converted into two-dimensional data, and the converted second data can be compared with the third data to determine whether the first scenario is present. The methods for converting two-dimensional data into three-dimensional data, and vice versa, can refer to the specific implementation in step S111.

In some embodiments of the present disclosure, if the target device is only capable of playing the first data, the first data is output when it is determined that the first scenario is present. This process improves the accuracy of target data output. For example, using AR devices, the real physical world can be seen, so when outputting the virtual object, there is no need to repeatedly output the surrounding environmental video captured along the virtual object. Therefore, the surrounding environmental video included in the target data, which was captured along with the virtual object, is not used for output display, but is only used for matching the environment expression.

In some embodiments of the present disclosure, the process of determining whether the first scenario is present includes: if the target device is a third type device, and the second data represents the two-dimensional and/or three-dimensional environment expression of the capture device at the time of collecting the first data, the third data is compared with the second data. If the two data are matched, it is determined that the first scenario is present. The third data represents the environment expression of the capture device at the time of collecting the third data, and the third data is two-dimensional and/or three-dimensional. During the comparison, the dimension of the third data is the same as the dimension of the second data.

S202 further includes either step S113a or step S113b. At S113a, if the target device is in the first mode, output the first data and second data in the first method; the second data is used to determine the consistency of the environment expression and for output display on the target device.

In this case, the third type device refers to a device that not only is capable of playing both the first data and the second data simultaneously, but also capable of playing the first data alone. Examples include mixed reality (MR) devices. The first mode refers to a mode where the target device is used to play both the first data and the second data, and in a scenario where the MR device is able to see the real world. In implementation, the target device displays the data after the first and second data are superimposed. In some embodiments, anchor points can be used to superimpose the first data on the second data.

In some embodiments of the present disclosure, if the dimension of the second data is the same as that of the third data, the second data and third data can be directly compared to determine whether the first scenario is present.

In some embodiments of the present disclosure, if the second data is three-dimensional and the third data is two-dimensional, the third data can first be converted into three-dimensional data, and then the converted third data can be compared with the second data to determine whether the first scenario is present. Alternatively, the second data can be converted into two-dimensional data, and the converted second data can be compared with the third data to determine whether the first scenario is present. The methods for converting two-dimensional data into three-dimensional data and vice versa can refer to the specific implementation in step S111.

In some embodiments of the present disclosure, if the second data is three-dimensional and the third data includes both two-dimensional and three-dimensional data, the second data can be compared with the three-dimensional portion of the third data to determine whether the first scenario is present.

At S113b, if the target device is in the second mode, outputting the first data in the first method without outputting the second data, wherein the second data is used to determine the consistency of the environment expression.

In this case, the second mode refers to a mode where the target device is used to play the first data, and in a scenario where the MR device is not able to see the real world. For example, the target device outputs the first data. In some embodiments, the first data can also be superimposed on the third data using anchor points and displayed on the target device.

In some embodiments of the present disclosure, if the target device is capable of playing the first and/or the second data, when it is determined that the first scenario is present, the target device outputs the target data corresponding to the device mode. This process improves the accuracy of target data output.

In some embodiments of the present disclosure, if the number of data units of the target data containing the second data is greater than a target quantity, the storage structure of each unit of the target data containing the second data is the first structure. The first structure includes one frame of the first data and one frame of the second data, wherein the one frame of the second data is index information. The index information is used to retrieve the corresponding environment expression data from the target information during the process of determining whether the first scenario is present. The target information contains all indexes and corresponding environment expression data.

In this case, the target quantity can be any suitable number, such as 3, 10, etc. In FIG. 5, one target data frame represents one quantity unit. A first structure indicates that the target data contains the index information for the second data. For example, when the target quantity is 5, and the quantity of second data contained in the target data is 10, this satisfies the condition that the number of data units of the target data containing the second data is greater than a target quantity, and the storage structure for each unit of target data containing the second data shall be the first structure.

The index information refers to the globally unique identifier (GUID) of the corresponding environment expression data. This index information can be a 128-bit binary identifier generated by an algorithm, representing the location of the second data in the target information.

In some embodiments of the present disclosure, by storing the environment expression in the target information, the corresponding index information for the environment expression can be obtained.

In some embodiments of the present disclosure, by using the storage structure of index information, the data transmission volume can be reduced, which in turn ensures faster encoding and decoding, improving data processing efficiency. This indexing storage method is applicable to all three types of devices mentioned in the above embodiments. For the second type device, when transmitting target data, only one frame of the second data is needed for comparison, saving transmission space. However, if each frame requires comparison, all second data frames must be transmitted.

In some embodiments of the present disclosure, if the number of data units of the target data containing the second data is less than the target quantity, the storage structure of each unit of the target data containing the second data is the second structure. The second structure includes one frame of first data and one frame of second data, wherein the frame of the second data contains the environment expression data.

In this case, the target quantity can be any suitable number, such as 3, 5, etc. The second structure indicates that the target data contains the second data. For example, when the target quantity is 3, and the number of the target data containing the second data is 2, this satisfies the condition that the number of data units of the target data containing the second data is less than the target quantity, and the storage structure for each unit of target data containing the second data shall be the second structure.

In some embodiments of the present disclosure, by directly transmitting the second data, the time required to obtain the second data is reduced. Moreover, since no additional memory is needed for storage, the consumption of storage resources is reduced. This indexing storage method is applicable to all three types of devices mentioned above. It works well for the second type device, but the effect might not be as good for the first and third types of devices, as the display of the environment during frame switching could be discontinuous, potentially causing screen flicker.

In some embodiments of the present disclosure, step S202 includes step S121, where:

At S121, in the case where the current biometric feature matches the biometric feature corresponding to the first data, the first data is output in the first method.

In this case, the biometric feature is determined based on the biological data of the user. The biometric features corresponding to different users are unique. This biological data can be any suitable type of data, such as eye movement data, voiceprint data, fingerprint data, etc.

In some embodiments of the present disclosure, different storage structures can be selected based on different biometric features. For example, if the user's biometric feature is fingerprint data, the second structure can be used to store this biometric feature; similarly, if the user's biometric feature is voiceprint data, the first structure can be used for storage. In practice, those skilled in the art can choose the storage structure for biometric features based on actual needs, and the embodiments of this disclosure do not impose limitations.

The methods for collecting biological data can include, but are not limited to, optical techniques and sensors. For example, using optical technology such as infrared projection to collect data on the user's facial features; or using sensors to capture biological data such as the user's movements, posture, voice, and facial expressions; and additionally, a microphone can be used to capture the user's voiceprint data.

The method for matching biometric features can involve calculating the distance or similarity between the current biometric feature and the biometric feature corresponding to the first data. Based on a set threshold, it is determined whether the current biometric feature matches the biometric feature corresponding to the first data. If the distance/similarity between the current biometric feature and the biometric feature corresponding to the first data exceeds the threshold, the match is considered successful.

In some embodiments of the present disclosure, by restricting the output of the first data only when the biometric feature is matching, the target data can be only displayed for specific users. The process improves the privacy and security of the target data.

The following content explains the information processing method provided by the present disclosure in real-world scenarios and applications. More specifically, point cloud information (corresponding to the aforementioned three-dimensional data) will be used as an example for the illustration.

In related technologies, in virtual reality, augmented reality, and other similar scenarios, it is often necessary to record mixed reality videos. This allows users to view images that combine real-world scenes with virtual objects, which improves the viewing experience of the user. However, currently, complete video content can be viewed in almost any scenario or by any user, which presents issues such as less privacy and low security.

The present disclosure provides an information processing method. In this method, by comparing the environment expression of the target data with the environment expression of the scenario, the target data can be output in different settings (e.g., displaying or not displaying the target data). This ensures that the target data is only displayed in specific scenarios, which improves the privacy and security. Additionally, the method for outputting the target data is determined through environment expression comparison, in contrast to using specific encryption methods to encrypt the target data, reduces the need for additional encryption resources. This reduces the consumption of storage resources on various devices (e.g., encryption and decryption ends). Moreover, since no extra encryption and decryption are required, this not only reduces resource consumption on each device but also increases the speed at which the target data is retrieved.

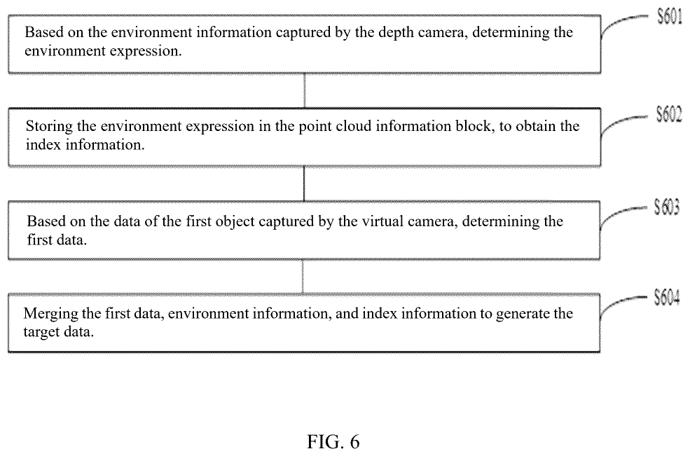

FIG. 6 is a flowchart illustrating a method for generating target data according to an embodiment of the present disclosure. As shown in FIG. 6, the process includes steps S601 to S604, where:
At S601, based on the environmental information captured by the depth camera (corresponding to the aforementioned capture device), determining the environment expression;
At S602, storing the environment expression in the point cloud information block (corresponding to the aforementioned target information), to obtain the index information;
At S603, based on the data of the first object captured by the virtual camera, determining the first data.

In this case, the data of the first object can be the environmental data of the current environment, where the virtual camera renders the first data. It can also be the virtual object's data of the first object.
At S604, merging the first data, environmental information, and index information to generate the target data.

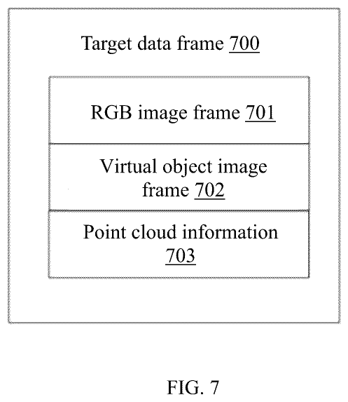

The environmental information in the target data for this step includes both two-dimensional RGB images and three-dimensional point cloud information. The two-dimensional RGB image is used for outputting to display, while the three-dimensional point cloud information is used for matching the environment expression. The three-dimensional point cloud information is stored using an indexing method. The first data in the target data is the image frame of a virtual object. The storage structure of the target data frame is shown in FIG. 7. FIG. 7 is a schematic diagram of a target data frame storage structure provided by an embodiment of the present disclosure, where the target data frame 700 includes an RGB image frame 701, a virtual object image frame 702, and point cloud information 703.

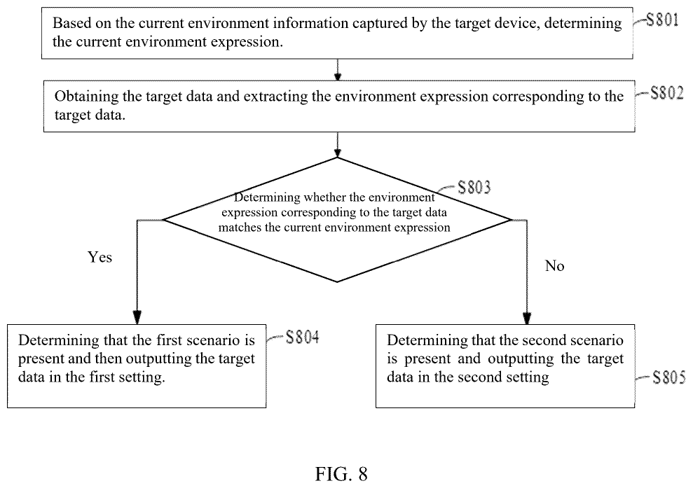

FIG. 8 is a flowchart illustrating the information processing method according to an embodiment of the present disclosure. As shown in FIG. 8, the method is applied to a target device and includes steps S801 to S805, where:
At S801, based on the current environmental information captured by the target device, determining the current environment expression;
At S802, obtaining the target data and extracting the environment expression corresponding to the target data.

In this case, step S801 can be performed either before step S802, or after step S802, or both steps can be performed simultaneously.
At S803, determining whether the environment expression corresponding to the target data matches the current environment expression; and if yes, the proceeding to S804; otherwise, proceeding to S805;
At S804, determining that the first scenario is present and then outputting the target data in the first method.

In this case, the first method can be displaying the target data. In some embodiments of the present disclosure, after determining that the first scenario is present but before outputting the target data in the first method, the current biometric feature can be compared with the biometric feature corresponding to the first data. If the two biometric data match, the target data is output in the first method; if not match, the target data is output in the second method.
At S805, determining that the second scenario is present and outputting the target data in the second method.

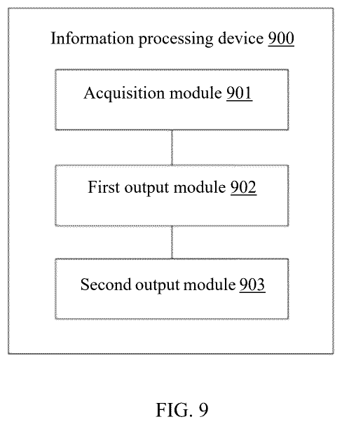

Based on the above embodiments, the present disclosure also provides an information processing device. FIG. 9 is a schematic diagram of the information processing device according to an embodiment of the present disclosure. As shown in FIG. 9, the information processing device 900 includes an acquisition module 901, a first output module 902, and a second output module 903. More specifically, the device includes:
Acquisition module 901, which is used to obtain target data;
First output module 902, which is used to output the target data in the first method if the first scenario is present;
Second output module 903, which is used to output the target data in the second method if the second scenario is present.

In this case, the first scenario is different from the second scenario. The environment expression of the first scenario matches to the environment expression of the target data, while the environment expression of the second scenario does not match to the environment expression of the target data.

In some embodiments of the present disclosure, the first method is displaying the target data on the target device, and the second method is not displaying the target data on the target device.

In some embodiments of the present disclosure, the acquisition module 901 is further configured to obtain the target data, which includes the first data and second data. The first data is data of a first object, and the second data represents the environment expression of the capture device at the time capturing the first data. The environment expression corresponding to the target data is reflected through the second data. The first output module 902 is further configured to output the first data in the first method. The second output module 903 is further configured to output the first data in the second method.

In some embodiments of the present disclosure, if the target device is a first type device, the second data represents the two-dimensional and/or three-dimensional environment expression of the capture device at the time of capturing the first data. The third data is compared with the second data, and if the two data are matched, it is determined that the first scenario is present. The third data represents the environment expression of the capture device at the time of capturing the third data, and the third data is two-dimensional and/or three-dimensional. During the comparison, the dimensionality of the third data is consistent with that of the second data. The first output module 902 is further configured to output the target data and the second data in the first method. The second data is used to determine the consistency of the environment expression, and for displaying on the target device.

In some embodiments of the present disclosure, if the target device is a second type device, the second data represents the two-dimensional or three-dimensional environment expression of the capture device at the time of collecting the first data. The third data is compared with the second data, and if the two data are matched, it is determined that the first scenario is present. The third data represents the environment expression of the capture device at the time of capturing the third data, and the third data is two-dimensional or three-dimensional. During the comparison, the dimension of the third data is the same as that of the second data. The first output module 902 is further configured to output the first data in the first method without outputting the second data. The second data is used for determining the consistency of the environment expression.

In some embodiments, if the target device is a third type device, the second data represents the two-dimensional and/or three-dimensional environment expression of the capture device at the time of capturing the first data. The third data is compared with the second data, and if the two data are matched, it is determined that the first scenario is present. The third data represents the environment expression of the capture device at the time of capturing the third data, and the third data is two-dimensional and/or three-dimensional. During the comparison, the dimension of the third data is the same as that of the second data. The first output module 902 is further configured to the following steps. If the target device is in the first mode, output the target data and the second data in the first method, wherein the second data is used for determining the consistency of the environment expression and for displaying on the target device; if the target device is in the second mode, output the first data in the first method without outputting the second data, wherein the second data is used for determining the consistency of the environment expression.

In some embodiments of the present disclosure, if the number of data units of the target data containing the second data is greater than a target quantity, the storage structure of each unit of the target data containing the second data is the first structure. The first structure includes one frame of the first data and one frame of the second data, wherein the one frame of the second data is index information. The index information is used to retrieve the corresponding environment expression data from the target information during the process of determining whether the first scenario is present. The target information contains all indexes and corresponding environment expression data.

In some embodiments of the present disclosure, if the number of data units of the target data containing the second data is less than the target quantity, the storage structure of each unit of the target data containing the second data is the second structure. The second structure includes one frame of first data and one frame of second data, wherein the frame of the second data contains the environment expression data.

In some embodiments of the present disclosure, the first output module 902 is further configured to output the first data in the first method, if the current biometric feature matches the biometric feature corresponding to the first data.

The description of the embodiments above about the device of the present disclosure, is similar to the description of the embodiments of the method of the present disclosure, and has similar beneficial effects as those of the method embodiments. The technical details not disclosed in the embodiments of the device of the present disclosure, can be referred to the descriptions in the embodiments of the present disclosure of the present disclosure for understanding.

Note that, in the embodiments of the present disclosure, if the above method is implemented in the form of software functional modules and sold or used as an independent product, is can also be stored in a computer-readable storage medium. Based on this understanding, the technical solutions of the embodiments of the present disclosure, in essence, or the parts that contribute to the related technology, can be embodied in the form of a software product. This software product is stored in a storage medium and includes the instructions to enable an electronic device (such as a personal computer, server, or network device, etc.) to execute all or part of the method described in the embodiments of the present disclosure. The aforementioned storage medium may include USB drives, portable hard drives, read-only memory (ROM), magnetic disks, optical discs, or any other media that can store program code. Therefore, the embodiments of this application are not limited to any specific combination of hardware and software.

The present disclosure provides an electronic device, which includes a memory and a processor. The memory stores a computer program that can be run on the processor, and when the processor executes the computer program, the aforementioned method is implemented.

The present disclosure provides a computer-readable storage medium, which stores the computer program. When the processor executes the computer program, the aforementioned method is implemented. The computer-readable storage medium can be volatile or non-volatile.

The present disclosure provides a computer program product. The computer program product includes a non-transitory computer-readable storage medium that stores a computer program, and when the computer program is read and executed by a computer, it implements some or all of the steps of the aforementioned method. This computer program product can be implemented through hardware, software, or a combination thereof. In one embodiment, the computer program product is specifically embodied as a computer storage medium, and in another embodiment, the computer program product is specifically embodied as a software product, such as a Software Development Kit (SDK), etc.

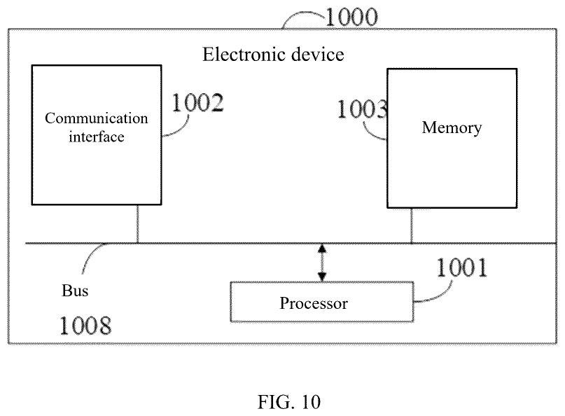

FIG. 10 is a schematic diagram of the hardware entity of an electronic device embodiment provided by the present disclosure. As shown in the figure, the hardware entity of the electronic device 1000 includes: a processor 1001, a communication interface 1002, and a memory 1003.

The processor 1001 typically controls the overall operation of the electronic device 1000.

The communication interface 1002 allows the electronic device to communicate with other terminals or servers via a network.

The memory 1003 is configured to store instructions and applications executable by the processor 1001, and it can also cache data to be processed by the processor 1001 or data that has been or will be processed by various modules of the electronic device 1000 (e.g., image data, audio data, voice communication data, and video communication data). The memory can be implemented through flash memory (FLASH) or random access memory (RAM). Data transmission between the processor 1001, communication interface 1002, and memory 1003 are processed through the bus 1004.

It should be noted that the descriptions of embodiments above, of the storage medium and device, are similar to those of the embodiments of the aforementioned method, and have similar beneficial effects as the embodiments of the method provided in the present disclosure. The technical details not disclosed in the embodiments of the storage medium and device of the present disclosure, can be referred to the descriptions in the embodiments of the method of the present disclosure for understanding.

It should be understood that the terms ‘an embodiment’ or ‘some embodiment’ mentioned throughout the specification mean that a particular feature, structure, or characteristic related to the embodiment is included in at least one embodiment of the present disclosure. Therefore, the phrases ‘in an embodiment’ or ‘in some embodiments’ appearing in various parts of the specification do not necessarily refer to the same embodiment. Furthermore, these particular features, structures, or characteristics may be combined in any suitable manner in one or more embodiments. It should be understood that in various embodiments of this application, the numbering of the steps/processes mentioned above does not imply the execution sequence. The execution sequence of the steps/processes should be determined by their functions and internal logic and should not impose any limitation on the implementation process of the embodiments of this application. The numbering of the embodiments is only for descriptive purposes and does not represent the relative superiority of the embodiments.

It should be noted that the terms “include”, “comprise” or any other variants thereof, as used herein, are intended to cover non-exclusive inclusion. This means that a process, method, article, or device that includes a set of elements not only includes those elements but may also include other elements not expressly listed or elements inherent to such process, method, article, or device. Without additional limitations, an element defined by the phrase “comprising a . . . ” does not exclude the presence of additional identical elements in the process, method, article, or device that includes the element.

In the various embodiments provided in the present disclosure, it should be understood that the disclosed device and method can be implemented in other ways. The embodiments of device described above are merely illustrative. For example, the division of units is merely a logical functional division, and other divisions may be adopted in actual implementation. For instance, multiple units or components can be combined or integrated into another system, or some features may be omitted or not executed. Furthermore, the coupling or communication connections between the various components displayed or discussed, whether direct coupling or communication connection, may be through some interfaces, devices, or indirect coupling or communication connections between units. These can be electrical, mechanical, or other forms.

The units described above as separate components may or may not be physically separated, and the components displayed as units may or may not be physical units; they can be located in one place or distributed across multiple network units. It is possible to select some or all of the units based on actual needs to achieve the objectives of the embodiment.

Furthermore, in the embodiments of the present disclosure, the functional units can either all be integrated into one processing unit, or each unit can exist independently as a separate unit, or two or more units can be integrated into a single unit. The integrated units can be implemented in the form of hardware or a combination of hardware and software functional units.

It should be understood by those skilled in the art that, all or part of the steps in the method embodiments described above can be implemented by hardware associated with program instructions. The aforementioned program can be stored in a computer-readable storage medium, and when executed, it performs the steps of the method embodiments described above. The aforementioned storage medium includes: mobile storage devices, read-only memory (ROM), magnetic disks, optical discs, and other media capable of storing program code.

Alternatively, if the integrated units described in this application are implemented in the form of software functional modules and sold or used as standalone products, they can also be stored in a computer-readable storage medium. Based on this understanding, the technical solutions of this application, in essence, or the parts that contribute to the related technology, can be embodied as software products. This computer software product is stored on a storage medium and includes several instructions that enable a computer device (which can be a personal computer, server, network device, etc.) to execute all or part of the methods described in the various embodiments of this application. The aforementioned storage media include: mobile storage devices, ROM, magnetic disks, optical discs, and other media capable of storing program code.

The above description is merely some embodiments of the present disclosure, and the protection scope of this application is not limited to this. Any variations or substitutions that are easily conceived by those skilled in the art within the technical scope disclosed in the present disclosure should also be covered within the protection scope of this disclosure.

What is claimed is:

1. An information processing method comprising:
obtaining target data;
in a first scenario, outputting the target data in a first method; and
in a second scenario, outputting the target data in a second method;
wherein:
the first scenario is different from the second scenario;
environment expression corresponding to the first scenario is consistent with environment expression corresponding to the target data; and
environment expression corresponding to the second scenario is inconsistent with the environment expression corresponding to the target data.

2. The method according to claim 1, wherein:
the first method includes displaying the target data on a target device; and
the second method includes not displaying the target data on the target device.

3. The method according to claim 1, wherein:
obtaining the target data includes:
obtaining the target data that includes first data and second data, wherein the first data is data of a first object, and the second data represents environment expression of a capture device at time of capturing the first data, and the environment expression corresponding to the target data is reflected by the second data;
outputting the target data in the first method includes:
outputting the first data in the first method; and
outputting the target data in the second method includes:
outputting the first data in the second method.

4. The method according to claim 3, wherein:
determining the first scenario includes:
in response to the target device being a first type device, and the second data being two-dimensional data and/or three-dimensional data corresponding to the environment expression of the capture device at the time of capturing the first data, comparing third data with the second data, and determining the first scenario when the third data matches the second data;
wherein the third data represents environment expression of the capture device at time of capturing the third data, the third data is two-dimensional data and/or three-dimensional data, and the third data and the second data have a same dimension during comparison; and
outputting the target data in the first method includes:
outputting the first data and the second data in the first method, wherein the second data is used for consistency determination of the environment expression and output display of the target device.

5. The method according to claim 3, wherein:
determining the first scenario includes:
in response to the target device being a second type device, and the second data being two-dimensional data or three-dimensional data corresponding to the environment expression of the capture device at the time of capturing the first data, comparing third data with the second data, and determining the first scenario when the third data matches the second data;
wherein the third data represents the environment expression of the capture device at time of capturing the third data, the third data is two-dimensional data or three-dimensional data, and the third data and the second data have a same dimension during comparison; and
outputting the target data in the first method includes:
outputting the first data in the first method without outputting the second data, wherein the second data is used for consistency determination of the environment expression.

6. The method according to claim 3, wherein:
determining the first scenario includes:
in response to the target device being a third type device, and the second data being two-dimensional data and/or three-dimensional data corresponding to the environment expression of the capture device at the time of capturing the first data, comparing third data with the second data, and determining the first scenario when the third data matches the second data;
wherein the third data represents the environment expression of the capture device at the time of capturing the third data, the third data is two-dimensional data and/or three-dimensional data, and the third data and the second data have a same dimension during comparison; and
outputting the target data in the first method includes:
in response to the target device being in a first mode, outputting the first data and the second data in the first method, wherein the second data is used for consistency determination of the environment expression and output display of the target device; and
in response to the target device being in a second mode, outputting the first data in the first method without outputting the second data, wherein the second data is used for consistency determination of the environment expression.

7. The method according to claim 6, wherein:
in response to a number of data units of the target data containing the second data is greater than a target quantity, a storage structure of the target data of each unit including the second data is a first structure;
the first structure includes one frame first data and one frame second data, the one frame second data is index information, and the index information is used to read corresponding environment expression data from the target information when determining the first scenario; and
the target information includes all indexes and corresponding environment expression data.

8. The method according to claim 6, wherein:
in response to the number of data units of the target data containing the second data is less than a target quantity, a storage structure of the target data of each unit including the second data is a second structure; and
the second structure includes one frame first data and one frame second data, and the one frame second data is environment expression data.

9. The method according to claim 6, wherein outputting the first data in the first method includes:
in response to a current biometric feature successfully matching a biometric feature corresponding to the first data, outputting the first data in the first method.

10. An information processing device, comprising:
an acquisition module configured to obtain target data;
a first output module configured to output the target data in a first method in a first scenario; and
a second output module configured to output the target data in a second method in a second scenario;
wherein:
the first scenario is different from the second scenario;
environment expression corresponding to the first scenario is consistent with environment expression corresponding to the target data; and
environment expression corresponding to the second scenario is inconsistent with the environment expression corresponding to the target data.

11. A non-transitory computer-readable storage medium storing a computer program that, when executed by a processor, causes the processor to:
obtain target data;
in a first scenario, output the target data in a first method; and
in a second scenario, output the target data in a second method;
wherein:
the first scenario is different from the second scenario;
environment expression corresponding to the first scenario is consistent with environment expression corresponding to the target data; and
environment expression corresponding to the second scenario is inconsistent with the environment expression corresponding to the target data.

12. The non-transitory computer-readable storage medium according to claim 11, wherein:
the first method includes displaying the target data on a target device; and
the second method includes not displaying the target data on the target device.

13. The non-transitory computer-readable storage medium according to claim 11, wherein the processor is further configured to:
obtain the target data that includes first data and second data, wherein the first data is data of a first object, and the second data represents environment expression of a capture device at time of capturing the first data, and the environment expression corresponding to the target data is reflected by the second data;
output the first data in the first method; and
output the first data in the second method.

14. The non-transitory computer-readable storage medium according to claim 13, wherein the processor is further configured to:
in response to the target device being a first type device, and the second data being two-dimensional data and/or three-dimensional data corresponding to the environment expression of the capture device at the time of capturing the first data, compare third data with the second data, and determine the first scenario when the third data matches the second data;
wherein the third data represents environment expression of the capture device at time of capturing the third data, the third data is two-dimensional data and/or three-dimensional data, and the third data and the second data have a same dimension during comparison; and
output the first data and the second data in the first method, wherein the second data is used for consistency determination of the environment expression and output display of the target device.

15. The non-transitory computer-readable storage medium according to claim 13, wherein the processor is further configured to:
in response to the target device being a second type device, and the second data being two-dimensional data or three-dimensional data corresponding to the environment expression of the capture device at the time of capturing the first data, compare third data with the second data, and determine the first scenario when the third data matches the second data;
wherein the third data represents the environment expression of the capture device at time of capturing the third data, the third data is two-dimensional data or three-dimensional data, and the third data and the second data have a same dimension during comparison; and
output the first data in the first method without outputting the second data, wherein the second data is used for consistency determination of the environment expression.

16. The non-transitory computer-readable storage medium according to claim 13, wherein the processor is further configured to:
in response to the target device being a third type device, and the second data being two-dimensional data and/or three-dimensional data corresponding to the environment expression of the capture device at the time of capturing the first data, compare third data with the second data, and determine the first scenario when the third data matches the second data;
wherein the third data represents the environment expression of the capture device at the time of capturing the third data, the third data is two-dimensional data and/or three-dimensional data, and the third data and the second data have a same dimension during comparison;
in response to the target device being in a first mode, output the first data and the second data in the first method, wherein the second data is used for consistency determination of the environment expression and output display of the target device; and
in response to the target device being in a second mode, output the first data in the first method without outputting the second data, wherein the second data is used for consistency determination of the environment expression.

17. The non-transitory computer-readable storage medium according to claim 16, wherein:
in response to a number of data units of the target data containing the second data is greater than a target quantity, a storage structure of the target data of each unit including the second data is a first structure;
the first structure includes one frame first data and one frame second data, the one frame second data is index information, and the index information is used to read corresponding environment expression data from the target information when determining the first scenario; and
the target information includes all indexes and corresponding environment expression data.

18. The non-transitory computer-readable storage medium according to claim 16, wherein:
in response to a number of data units of the target data containing the second data is less than a target quantity, a storage structure of the target data of each unit including the second data is a second structure; and
the second structure includes one frame first data and one frame second data, and the one frame second data is environment expression data.

19. The non-transitory computer-readable storage medium according to claim 16, wherein the processor is further configured to:
in response to a current biometric feature successfully matching a biometric feature corresponding to the first data, output the first data in the first method.
